(19) United States
(12) Patent Application Publication
(10) Pub. No.: US 2006/0074772 A1
(43) Pub. Date: Apr. 6, 2006

(54) Product registration apparatus, product registration control method, and program

(75) Inventors: Shouta Kamasaki, Kawasaki (JP); Takashi Toyokawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/283,685

(22) Filed: Nov. 22, 2005

Related U.S. Application Data
(63) Continuation of application No. PCT/JP03/08913, filed on Jul. 14, 2003.

(51) Int. Cl. G06Q 30/00

(52) U.S. Cl. 705/26

(57) ABSTRACT

A screen keyboard has an operation screen with an arrangement of product keys displayed on a display panel having disposed thereon a touch panel, thereby causing a product registration operation through an operation of a product key. A screen transition control unit causes a main operation screen to be displayed on the display panel of the screen keyboard, and also causes a screen selection key to be displayed. After switching from the main operation screen to another operation screen in accordance with an operation on the screen selection key, the screen transition control unit recognizes satisfaction of a predetermined condition, such as a lapse of a prescribed time, and then automatically effects a transition to the main operation screen.

This application is a continuation of PCT/JP03/8913, filed Jul. 14, 2003

### TECHNICAL FIELD

The present invention relates to a product registration apparatus, product registration control method, and program for use in a POS system for product registration by using a screen keyboard on a display panel provided with a touch panel and, particularly, to a product registration apparatus, product registration control method, and program for product registration while switching an operation screen on the display panel.

### BACKGROUND ART

Conventionally, in a POS system used in a supermarket or the like, a POS device unit including a scanner for reading a bar code, a card reader, an LCD panel with a touch panel for use as a screen keyboard, a keyboard, and others is disposed in a product checkout lane separately from a POS main-body device with a cash register. The POS device unit disposed in the checkout lane reads the bar code of a product by the scanner, and performs a calculation process with the number of products being inputted through a numeric keypad. If no bar code is provided to the product, a screen key is operated to display a unit price, and then the number of products is inputted through the numeric keypad for a calculation process.

In such a conventional POS system, for product registration by using a screen keyboard with a touch panel on which product keys are arranged, a main operation screen (default operation screen) displayed in an initial state is normally configured so as to have laid out thereon product keys indicating product names that may be used with a high frequency. When the number of products is increased, a plurality of operation screens are provided, and these operation screens are switched thereamong by pressing a screen selection key.

However, in product registration by using a screen keyboard through a display screen with a touch panel, in order to register a product, when the main operation screen is switched to another operation screen for product registration with a product key for a product to be next registered being located on the main operation screen, a screen selection operation is required for putting the operation screen back to the main operation screen. Therefore, in order to register a product that is not listed on the main operation screen, an operation of switching from the main operation screen to another operation screen and an operation of putting the operation screen back to the original main operation are required. Thus, it takes taking time and effort to perform a registration task.

Moreover, product registration is performed through scanner reading if a product is with a bar code, and product registration is performed through an operation on keys on the screen keyboard if a product is without a bar code. Thus, a product registration task includes scanner reading and key operation. For this reason, after a product is registered by switching from the main operation screen to another operation screen, the next product may be registered through scanner reading, and then the task may again return to the operation screen for product registration. The operation screen at this time, however, remains as the one previously switched, and therefore has to be first put back to the main operation screen for product registration through a product key. This screen switching operation causes a delay by one step in product registration operation through a product key, thereby posing a problem of disturbing the rhythm of a key operation for product registration and making operability difficult.

### DISCLOSURE OF INVENTION

An object of the present invention is to provide a product registration apparatus, product registration control method, and program allowing easy product registration through a main operation screen to be used with a high frequency by, after switching to an operation screen other than the main operation screen and registering a product through a product key, effecting a transition to the main operation screen without requiring a key operation.

The present invention provides a product registration apparatus for use in a POS system. The product registration apparatus includes a screen keyboard that displays an operation screen having product keys arranged on a display panel having disposed thereon a touch panel, the screen keyboard causing a product registration process by an operation of the product keys; and a screen transition control unit that causes a main operation screen and a screen selection key to be displayed on the display panel of the screen keyboard, recognizes satisfaction of a predetermined condition after switching from the main operation screen to another operation screen in accordance with an operation on the screen selection key, and effects a transition to the main operation screen.

Therefore, according to the product registration apparatus of the present invention, when product registration is performed by switching from the main operation screen to another operation screen, upon satisfaction of a predetermined condition, a screen transition control for putting the operation screen back to the main operation screen is automatically performed without requiring a key operation. Therefore, without requiring an operation of returning to the main operation screen, attention can be focused on an operation for product registration, thereby allowing product registration with operation-screen switching to be performed promptly and efficiently.

As the recognition of satisfaction of the condition for effecting a transition to the main operation screen, upon recognition of product registration by a scanner that reads a bar code of a product, the screen transition control unit may effect a transition to the main operation screen. Therefore, when the procedure returns from product registration through the scanner to product registration through the screen keyboard, the main operation screen, which is used with a high frequency, is always displayed, thereby allowing efficient product registration through the screen keyboard.

As the recognition of satisfaction of the condition for effecting a transition to the main operation screen, upon recognition of an operation on a product key on the operation screen after switching, the screen transition control unit effects a transition to the main operation screen from the operation screen after switching. Since it is probable that, after product registration is performed through an operation of a product key on a screen other than the main operation screen, the next registration operation will be on the main operation screen, the product key operation causes a transition to the main operation screen for the next product registration.

As the recognition of satisfaction of the condition for effecting a transition to the main operation screen, the screen transition control unit monitors an elapsed time from a time when the main operation screen is switched to the other operation screen, and, upon recognition of an operation on a product key, resets the elapsed time to start monitoring the elapsed time from the beginning, and upon recognition of a lapse of a predetermined time without an operation on a product key, effects a transition to the main operation screen. As such, an elapsed time after switching is monitored, and a lapse of a predetermined threshold time causes the operation screen to be put back to the main operation screen, thereby allowing efficient product registration by using the screen keyboard without being aware of an operation of putting the operation screen back to the main screen.

In addition to a control of effecting a transition to the main operation screen by monitoring an elapsed time, the screen transition control unit effects a transition to the main operation screen upon recognition of a key operation through a physical keyboard separately provided to the screen keyboard while monitoring the elapsed time. Therefore, even if the elapsed time does not meet the threshold time, a transition to the main operation screen is effected with an operation on a specific physical key, for the next product registration. For example, a transition to the main operation screen is effected upon recognition of an operation on a number-of-products key, a discount key, or a correction key through a physical keyboard.

The screen transition control unit may effect a transition to the main operation screen upon recognition of non-detection of a checker by a sensor mounted on a scanner that reads a bar code of a product. At product registration, a checker picks up a product from a basket and then moves it to another basket. The movement of the body of the checker from the front of the scanner to the position of the other basket is detected by the sensor. Upon recognition of non-detection of the checker, a screen transition to the main operation screen is effected.

The screen transition control unit may effect a transition to the main operation screen upon detection, by a sensor, of a movement of a registered product to a basket. The screen transition control unit may effect a transition to the main operation screen upon detection of a change in weight of the basket, the detection being made by a load sensor disposed on a lane on which a basket accommodating a product is placed.

The present invention provides a product registration control method with a screen keyboard that displays an operation screen having product keys arranged on a display panel having disposed thereon a touch panel, the screen keyboard causing a product registration process by an operation of the product keys. This product registration control method includes:

an initial displaying step of causing a main operation screen and a screen selection key to be displayed on the display panel having disposed thereon the touch panel of the screen keyboard;

a screen switching step of switching from the main operation screen to another operation screen in accordance with an operation on the screen selection key; and

an initial screen transition step of recognizing satisfaction of a predetermined condition after the switching to the other operation screen, and effecting a transition to the main operation screen.

Here, in the screen transition step, an elapsed time from a time when the main operation screen is switched to the other operation screen is monitored, and, upon recognition of an operation on a product key, the elapsed time is reset to start monitoring the elapsed time from the beginning, and upon recognition of a lapse of a predetermined time without an operation on a product key, a transition to the main operation screen is effected. The screen transition control step effects a transition to the main operation screen upon recognition of a key operation through a physical keyboard separately provided to the screen keyboard while monitoring the elapsed time.

The present invention provides a program to be executed on a computer of a product registration apparatus including a screen keyboard that displays an operation screen having product keys arranged on a display panel having disposed thereon a touch panel, the screen keyboard causing a product registration process by an operation of the product keys. This program causes the computer to perform steps including:

an initial displaying step of causing a predetermined main operation screen and a screen selection key to be displayed on the display panel having disposed thereon the touch panel of the screen keyboard;

a screen switching step of switching from the main operation screen to another operation screen in accordance with an operation on the screen selection key; and

an initial screen transition step of recognizing satisfaction of a predetermined condition after the switching to the other operation screen, and effecting a transition to the main operation screen.

In this program, in the screen transition step, an elapsed time from a time when the main operation screen is switched to the other operation screen is monitored, and, when an operation on a product key is recognized, the elapsed time is reset to start monitoring the elapsed time from the beginning, and when a lapse of a predetermined time is recognized without an operation on a product key, a transition to the main operation screen is effected. Furthermore, the screen transition control step effects a transition to the main operation screen upon recognition of a key operation through a physical keyboard separately provided to the screen keyboard while monitoring the elapsed time.

Note that other details of the product registration control method and program are basically identical to those of the product registration apparatus.

### BRIEF DESCRIPTION OF DRAWINGS

FIG. 1 is a drawing for describing a POS system to which the present invention is applied;

FIG. 2 is a drawing for describing a hardware configuration of the POS system of FIG. 1;

FIG. 3 is a block diagram of a functional configuration representing an embodiment according to the present invention;

FIGS. 4A to 4C are drawings for describing a main operation screen displayed on an LCD panel according to the present invention;

FIG. 5 is a flowchart of a control process for effecting a transition to the main operation screen through a scanner input, according to the present invention;

FIG. 6 is a flowchart of a control process for effecting a transition to the main operation screen by pressing a product key, according to the present invention;

FIG. 7 is a flowchart of a control process for effecting a transition to the main operation screen by monitoring time;

FIG. 8 is a flowchart continued from FIG. 7 of the control process;

FIG. 9 is a flowchart of a control process for effecting a transition to the main operation screen by monitoring time and pressing a physical key, according to the present invention;

FIG. 10 is a flowchart continued from FIG. 9 of the control process;

FIG. 11 is a block diagram of a functional configuration for effecting a transition to the main operation screen by detecting a predetermined condition through a dedicated sensor, according to another embodiment of the present invention;

FIG. 12 is a drawing for describing a POS system provided with a sensor for detecting a movement of a product to a basket;

FIG. 13 is a drawing for describing a POS system provided with a load sensor for detecting a change in weight when a product is put in a basket;

FIG. 14 is a drawing for describing a POS system in which a scanner is provided with a sensor for detecting a movement of a checker; and

FIG. 15 is a flowchart of a control process for effecting a transition to the main operation screen by detecting a condition through a dedicated sensor, according to the present invention.

### BEST MODE FOR CARRYING OUT THE INVENTION

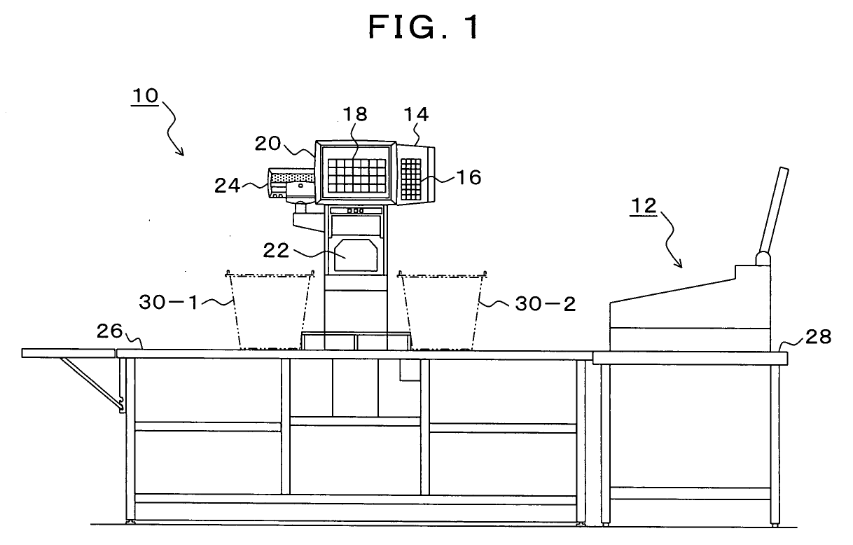

FIG. 1 is a drawing for describing a POS system to which a product registration control of the present invention is applied. In FIG. 1, the POS system is configured by a POS device unit 10 and a POS main-body device 12. The POS device unit 10 includes an electronic multiple item keyboard 14, a scanner unit 22, and a customer display unit 24. The electronic multiple item keyboard 14 includes a physical keyboard 16 using a numerical keypad with 4×8 keys and a screen keyboard 18 achieved by an LCD panel 20 having disposed on its screen a touch panel. The above-configured POS device unit 10 is placed on a desk 28 disposed in a checkout lane in a shop. A checker picks up products one by one from a shopping basket 30-1 containing the products to be purchased by a user, and then causes a bar code to be read by the scanner unit 22 for product registration or provides keyboard inputs using the screen keyboard 18 and the physical keyboard 16 on the electronic multiple item keyboard 14 for product registration. The POS main-body device 12 includes a cash register that is put on the desk 28 for a product settlement task performed by an operator based on product registration through an input from the POS device unit 10.

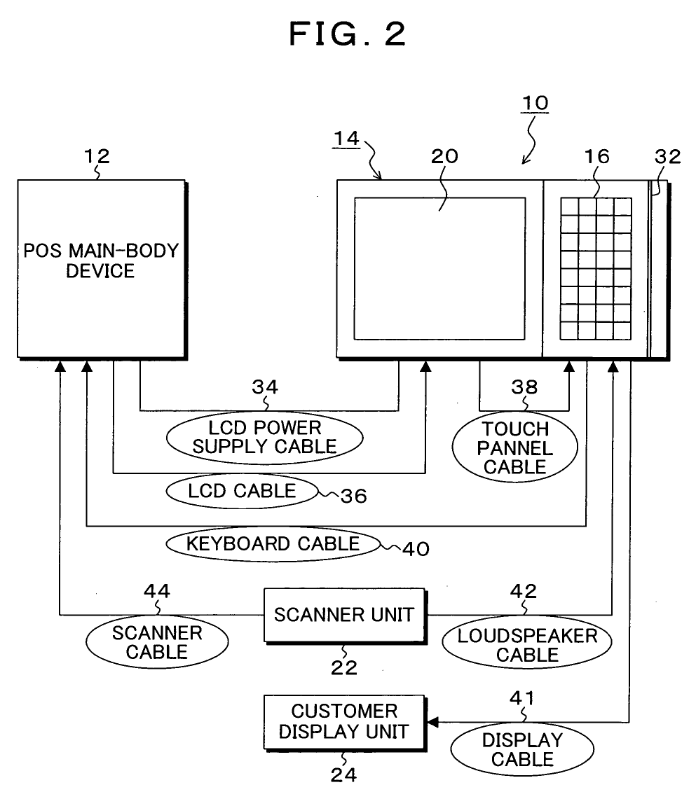

FIG. 2 is a drawing of a hardware configuration of the POS system of FIG. 1. In FIG. 2, from the POS main-body device 12 to the LCD panel 20 of the electronic multiple item keyboard 14, an LCD power supply cable 34 is connected, and also an LCD cable 36 is connected for screen display on the LCD panel 20. On the screen of the LCD panel 20, a touch panel is disposed, and from this touch panel to the physical keyboard 16 side, a touch panel cable 38 is connected. A card reader 32 is provided on the right side of the physical keyboard 16. Furthermore, a keyboard cable 40 is connected from the physical keyboard 16 to the POS main-body device 12. Also, from the scanner unit 30, a scanner cable 44 is connected to the POS main-body device 12 and a loudspeaker cable 42 is connected to the electronic multiple item keyboard 14 side. The loudspeaker cable 42 allows a click sound to be produced from a loudspeaker incorporated in the electronic multiple item keyboard 14 when the scanner unit 22 reads a bar code. Still further, a display cable 41 is connected from the electronic multiple item keyboard 14 to the customer display unit 24. Here, the physical keyboard 16 provided on the electronic multiple item keyboard 14 includes a numerical keypad with 4×8 keys, each key being assigned any one of numerals from 0 to 9, computation signs such as “×”, “−”, and “%”, and, further, predetermined function keys. An example of the function keys in this case is a number-of-products key, a discount key, or a correction key.

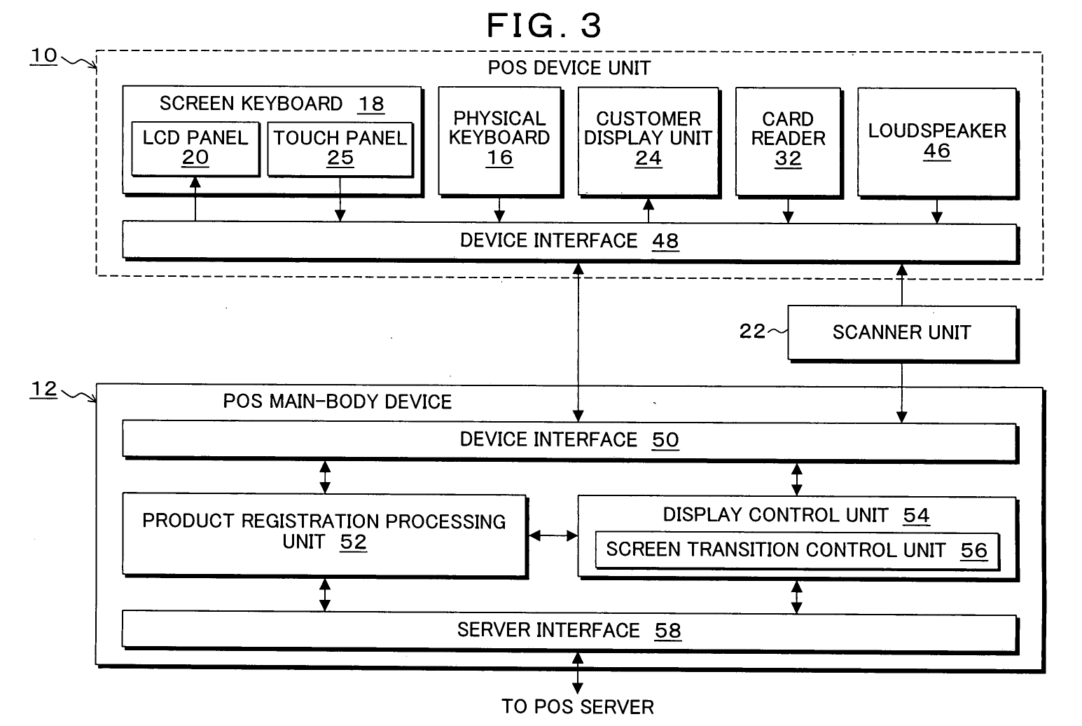

FIG. 3 is a block diagram of a functional configuration representing an embodiment of the product registration control according to the present invention. In FIG. 3, the POS device unit 10 side is provided with, as shown in FIG. 1, the screen keyboard 18 including the LCD panel 20 and the touch panel 25, the physical keyboard 16, the customer display unit 24, the card reader 32, and the loudspeaker 46, these components being connected to a device interface 48 and, from the device interface 48, being connected to the POS main-body device 12. The POS main-body device 12 achieves a function as a product registration apparatus according to the present invention, and includes a device interface 50, a product registration processing unit 52, a display control unit 54, and further a server interface 58. Of these, the display control unit 54 is provided with a screen transition control unit 56 for performing a product registration process according to the present invention. Furthermore, the scanner unit 22 is provided for product registration by reading a bar code of a product. The scanner unit 22 is connected to the device interface 50 of the POS main-body device 12, and is also connected to the loudspeaker 46 of the POS device unit 10 via the device interface 48. The product registration processing unit 52 provided in the POS main-body device 12 monitors an input from the POS device unit 10 or the scanner unit 22; upon determining that an input for product registration is present, that is, an input of reading a bar code of a product by the scanner unit 22 or pressing of a product key on an operation screen displayed on the LCD panel of the screen keyboard 18 is present, performs a product registration process based on product code information received associated with this input; simultaneously refers to unit-price database provided in advance for each product to calculate the cost per product and causes a total amount to be displayed on the customer display unit 24 side; and issues a receipt after a settlement process for payment is completed by an operator, thereby causing a series of product registration processes to be terminated.

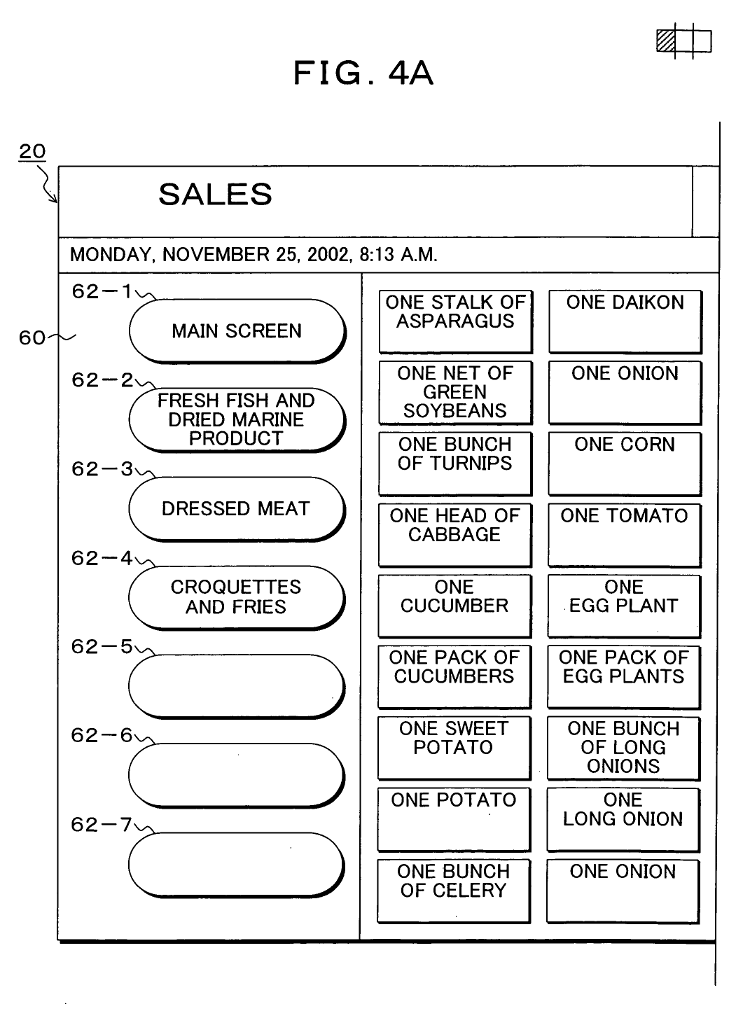

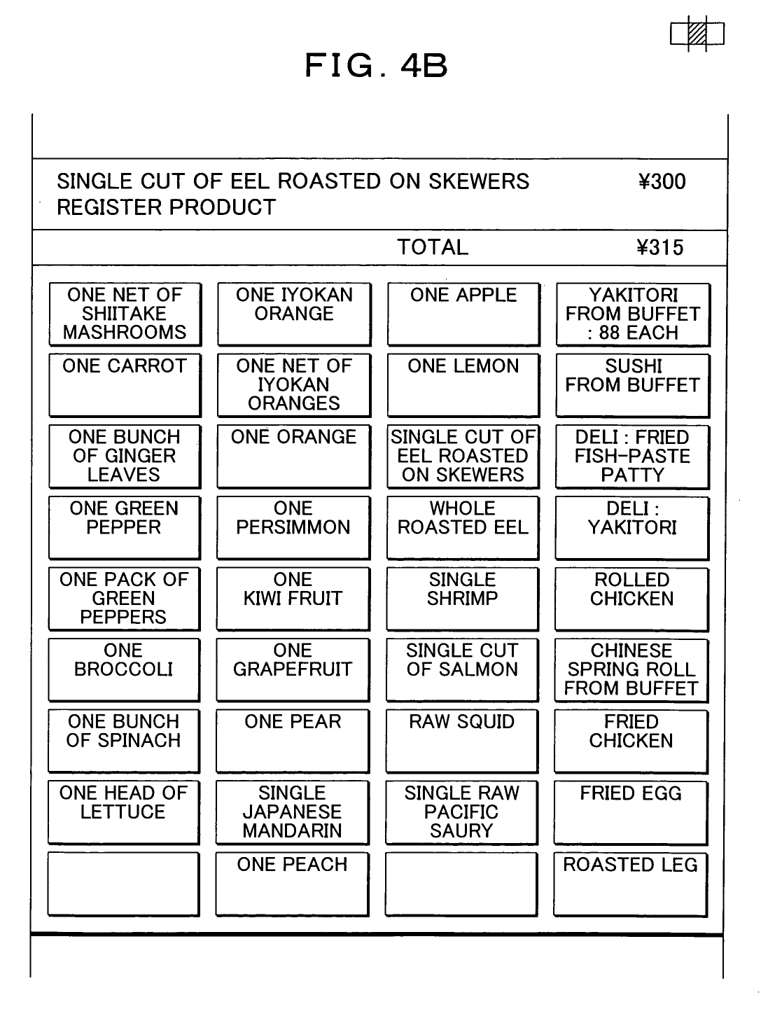

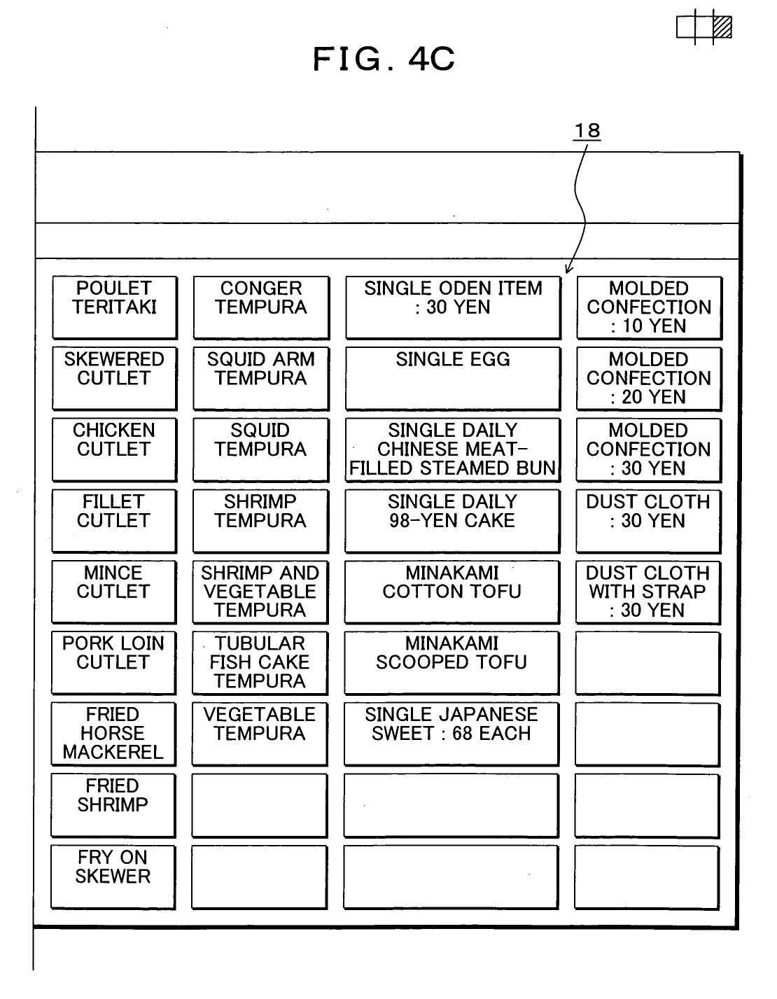

The display control unit 54 performs an operation-screen display control over the LCD panel 20 of the screen keyboard 18. The display control unit 54 causes a main operation screen as shown in FIGS. 4A to 4C to be displayed on the LCD panel 20. On the main operation screen of FIGS. 4A to 4C, a screen selection area 60 is provided on the left end of the screen. The screen selection area 60 is provided with, in addition to a basic screen selection button 62-1, screen selection buttons 62-2 to 62-7 for selecting other operation screens. In the present embodiment, the screen selection buttons 62-2, 62-3, and 62-4 are usable. Screens selected through the screen selection button 62-1 to 62-4 are a first screen of a basic screen shown in the drawing, then a second screen of an operation screen for fresh fish and dried marine product, a third screen of dressed-meat operation screen, and further a fourth screen for deli, such as croquettes and fries. Each of these operation screen are provided in advance in a database for screen display in addition to the basic screen.

The screen keyboard 18 displayed on the main operation screen of FIGS. 4A to 4C has an arrangement of 9×10=90 product keys with nine keys high and ten keys wide, each product key having displayed thereon a product name and the number of products. For example, a product key on the upper-left corner has displayed thereon “one stalk of asparagus”. Such product keys arranged on the main operation screen are those for products with a high frequency of product registration. Also, information about the product keys on the main operation screen and other operation screens to be displayed on the LCD panel 20 is generated at the POS server side connected to the POS main-body device 12, and is then transferred to the POS main-body device 12 to be caused by the display control unit 54 to be displayed on the LCD panel 20.

Referring again to FIG. 3, in an initial state, the display control unit 54 of the POS main-body device 12 causes the main operation screen shown in FIGS. 4A to 4C to be displayed on the LCD panel 20. At product registration, when the checker presses any one of the screen operation keys 62-2 to 62-4 other than the screen selection button 62-1 for the main operation screen provided in the screen selection area 60, the selected operation screen is displayed through switching. After switching to the operation screen other than the main operation screen, when the screen selection button 62-1 for the main operation screen is pressed, the main operation screen can be back on display again.

In the product registration control according to the present invention, the main operation screen as shown in FIGS. 4A to 4C are caused to be displayed on the LCD panel 20 by the screen transition control unit 56 of the display control unit 54. Also, as shown in the screen selection area 60, the screen selection keys 62-2 to 62-7 are displayed and, after switching from the main operation screen to another operation screen by an operation of any one of the screen selection keys 62-2 to 62-7, satisfaction of a predetermined condition is recognized, thereby effecting a screen transition to the main operation screen. Therefore, after switching from the main operation screen to another operation screen, the checker does not have to perform an operation of putting the operation screen back to the main operation screen, but a screen transition to the original main operation screen can be automatically effected.

Conditions for this screen transition to the main operation screen are listed as follows.

(1) A transition to the main operation screen is effected upon recognition of product registration through a scanner input based on bar-code reading by the scanner unit 22.

(2) A transition to the main operation screen is effected upon recognition of product registration by pressing a product key.

(3) An elapsed time after switching to an operation screen other than the main operation screen is monitored, and when a time exceeds a predetermined time, a transition to the main operation screen is effected.

(4) In addition to a transition to the main operation screen by monitoring an elapsed time described in (3), a transition to the main operation screen is effected upon recognition of an operation on a physical keyboard, such as a number-of-products key, a discount key, or a correction key.

(5) A predetermined condition requiring a transition to the main operation screen is detected by a dedicated sensor and, upon detection of the condition by the sensor, a transition to the main operation screen is effected.

A procedure of the product registration process according to the present invention including the above-described screen transition control for effecting a transition to the main operation screen upon recognition of satisfaction of a predetermined condition is described below.

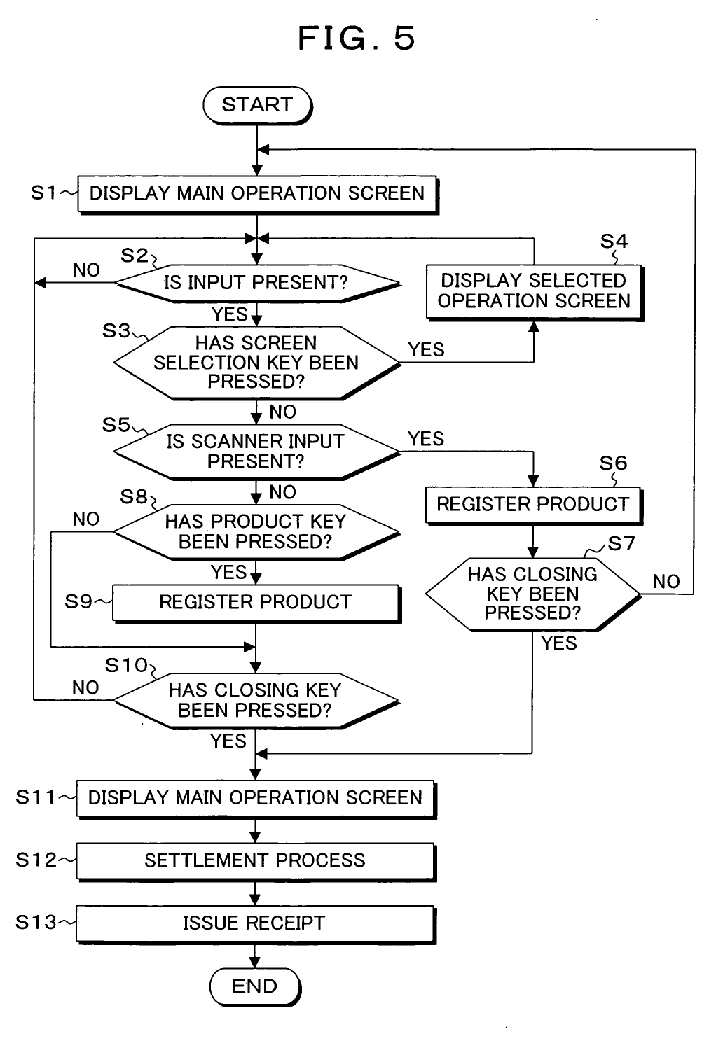

FIG. 5 is a flowchart of a control process according to the present invention for effecting a transition to the main operation screen through a scanner input. In FIG. 5, in step S1, the main operation screen is displayed on the LCD panel 20 as an initial state. In step S2, it is checked whether an input from the POS device unit 10 or the scanner unit 22 is present. If it is determined in step S2 that an input is present, the procedure goes to step S3, wherein it is checked whether a screen selection key has been pressed. If a screen selection key has been pressed, the procedure goes to step S4, wherein switching is made to display the selection-operated operation screen, and then the procedure again returns to step S2. If it is determined, after switching to an operation screen other than the main operation screen, that an input is present and it is determined in step S3 that no screen selection key is pressed, the procedure goes to step S5 to check whether a scanner input is present. At this time, if the checker performs reading of a bar code of a product through the scanner unit 22, it is determined that a scanner input is present, and then in step S6, product registration is performed based on the scanner input. Then, it is checked in step S7 whether a closing key has been pressed. If the closing key has not been pressed, the procedure returns to step S1 to effect a transition to the main operation screen. That is, when a scanner input is provided after the checker operates a screen selection key to switch to an operation screen other than the main operation screen, a transition to the main operation screen is automatically effected. On the other hand, if no scanner input is present in step S5 and it is determined in step S8 that a product key has been pressed, product registration is performed in step S9 based on the pressing of the product key. Also in this case, it is determined in step S10 whether the closing key has been pressed, and if the closing key has not been pressed, the procedure again returns to step S2 for waiting for the next input. When the closing key is pressed after product registration through pressing of a product key or a scanner input, it is determined as such in step S7 or step S10. Then in step S11, a screen transition to the main operation screen is effected in step S11. Then in step S12, a settlement process for receiving payment of the total amount of the registered products is performed. Then in step S13, a receipt is issued, thereby causing a series of process registration processes to be terminated. According to the control process of FIG. 5 for effecting a screen transition to the main operation screen through a scanner input, when the checker switches from the main operation screen to another operation screen through the screen keyboard with an operation on a screen selection key and performs product registration through a product key, if a scanner input is then provided by reading a bar code with the scanner unit 22, a transition to the main operation screen is automatically effected. Then, when the checker tries to perform product registration from a product key, the main operation screen is always back on display. Therefore, an operation on a screen selection key for putting the operation screen back to the main operation screen is not required, thereby reducing the number of checker's operations and increasing task efficiency in product registration.

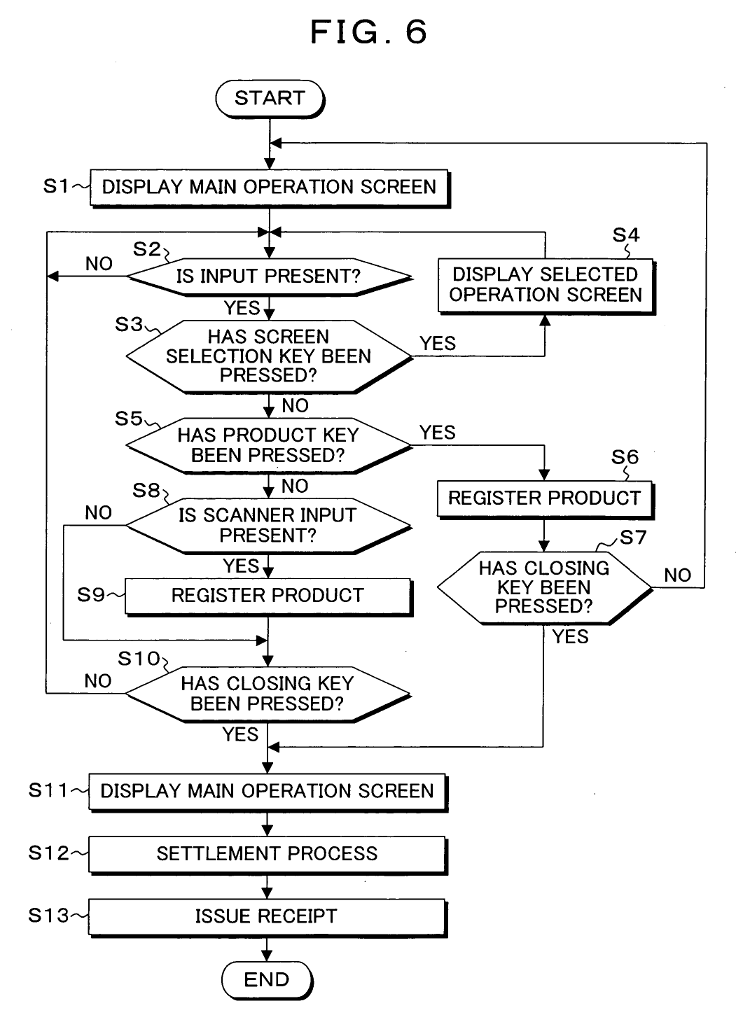

FIG. 6 is a flowchart of a control process for effecting a transition to the main operation screen by pressing a product key, according to the present invention. The control of FIG. 6 for effecting a transition to the main operation screen by pressing a product key is different from the control of FIG. 5 for effecting a transition to the main operation screen through a scanner input n that “Is scanner input present?” in step S5 is replaced by “Has product key been pressed?” and “Has product key been pressed?” in step S8 is replaced by “Is scanner input present?”, but other processes are basically identical to those in the flowchart of FIG. 5. That is, in the control process of FIG. 6 for effecting a transition to the main operation screen by pressing a product key, in a state of an initial display of the main operation screen in step S1, it is selected in step S2 that an input is present, and if this input is a pressing of a screen selection key in step S3, switching is made in the step S4 to the selection-operated operation screen other than the main operation screen. When a product key is pressed after this switching to the operation screen, it is determined in step S5 that the product key has been pressed, and then product registration is performed in step S6. Then, on condition that it is determined in step S7 that the closing key has not been pressed, the procedure returns to step S1, wherein a screen transition for a display of the main operation screen is automatically effected. Therefore, in the control process of FIG. 6, when the checker switches from the main operation screen to another operation screen and then performs product registration by pressing a product key on the operation screen after switching, a transition is made to the original main operation screen. Thus, even with switching from the main operation screen to another operation screen, the main operation screen serving as an initial state is always back on display upon product key registration, thereby allowing product registration with product keys.

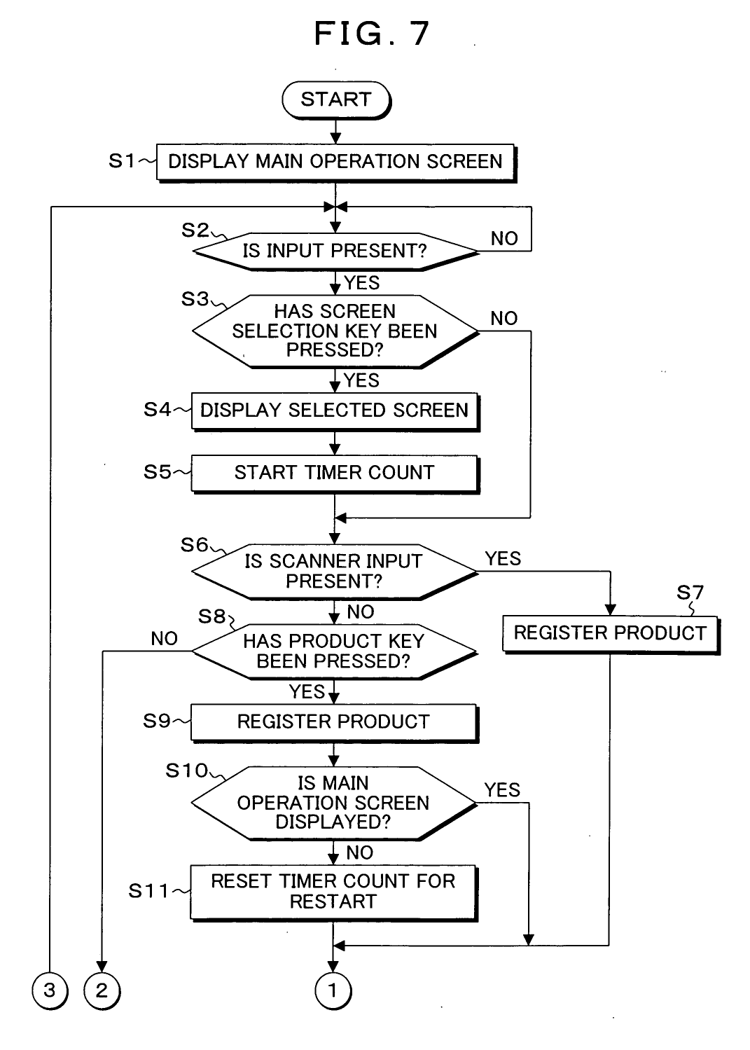

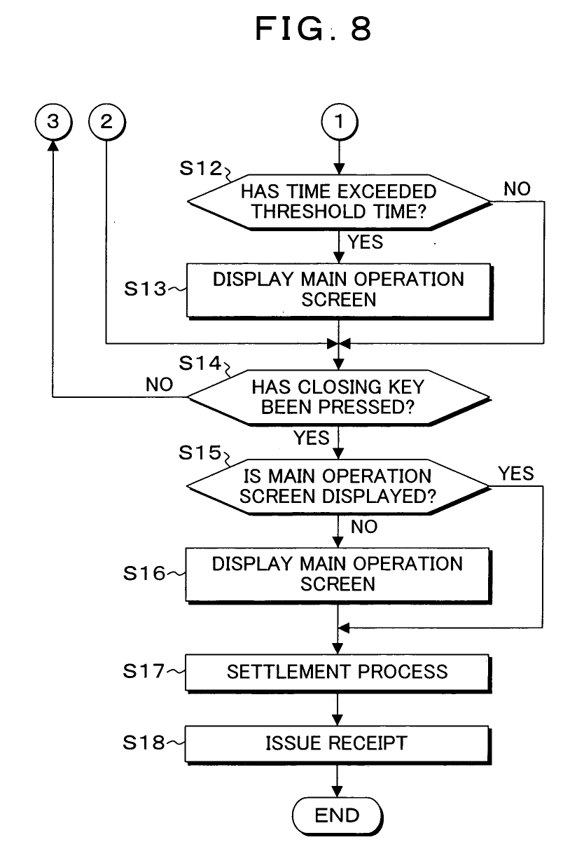

FIGS. 7 and 8 depict a flowchart of a control process for effecting a transition to the main operation screen by monitoring time, according to the present invention. In FIG. 7, the main operation screen is displayed in step S1 as an initial state. When it is determined in step S2 that an input is present, the procedure goes to step S3. Then, if a screen selection key has been pressed, the procedure goes to step S4 for display of the selected screen. Simultaneously with the display of the selected screen, timer count is started in step S5. Then, if a scanner input is present in step S6, product registration is performed in step S7. Also, if a product key is pressed in a state where switching to an operation screen other than the main operation screen has been effected, it is determined in step S8 that a product key has been pressed, and then product registration is performed in step S9. Then in step S10, it is checked whether the main operation screen is displayed. If the main operation screen is not displayed, the time count started in step S5 is reset in step S11 for restart based on the product registration by pressing a product key. It is then checked in step S12 of FIG. 8 whether the value of the timer count exceeds a predetermined threshold time. At this time, if the value exceeds the threshold time, the procedure goes to step S13, wherein a screen transition for switching to a display of the main operation screen is effected. If the value does not exceed the threshold time, the process of step S13 is skipped to continue the display of the operation screen other than the main operation screen. In step S14, it is checked whether the closing key has been pressed, and if the closing key has been pressed, the procedure goes to step S15, wherein it is checked whether the main operation screen is currently displayed. If the main operation screen is not displayed, a transition to the main operation screen is effected in step S16, a settlement process for payment of the total amount for the registered products is performed in step S17, and then a receipt is issued in step S18. As such, in the control process according to the present invention, a time from switching of the operation screen until pressing a product key is statistically calculated and is then set as a threshold time. If a product key is not pressed until the threshold time comes, a transition to the main operation screen is automatically effected. Therefore, with the threshold time for waiting for a product key input after screen switching being appropriately set, it is possible to effect a transition to the main operation screen so as not to hinder checker's input timing onto the touch panel. It is also advantageous to set, as the timing for effecting a transition to the main operation screen in this case, an appropriate time according to, for example, the degree of skill of the checker or the like by adjusting the threshold time for determining the elapsed time of the timer account.

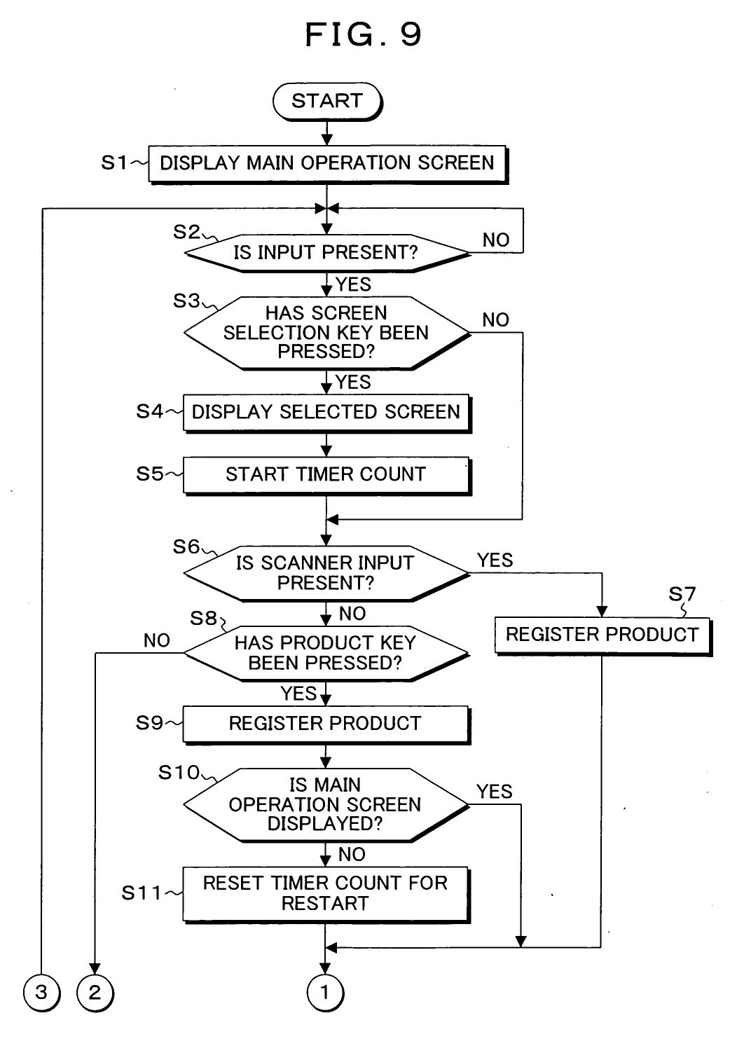

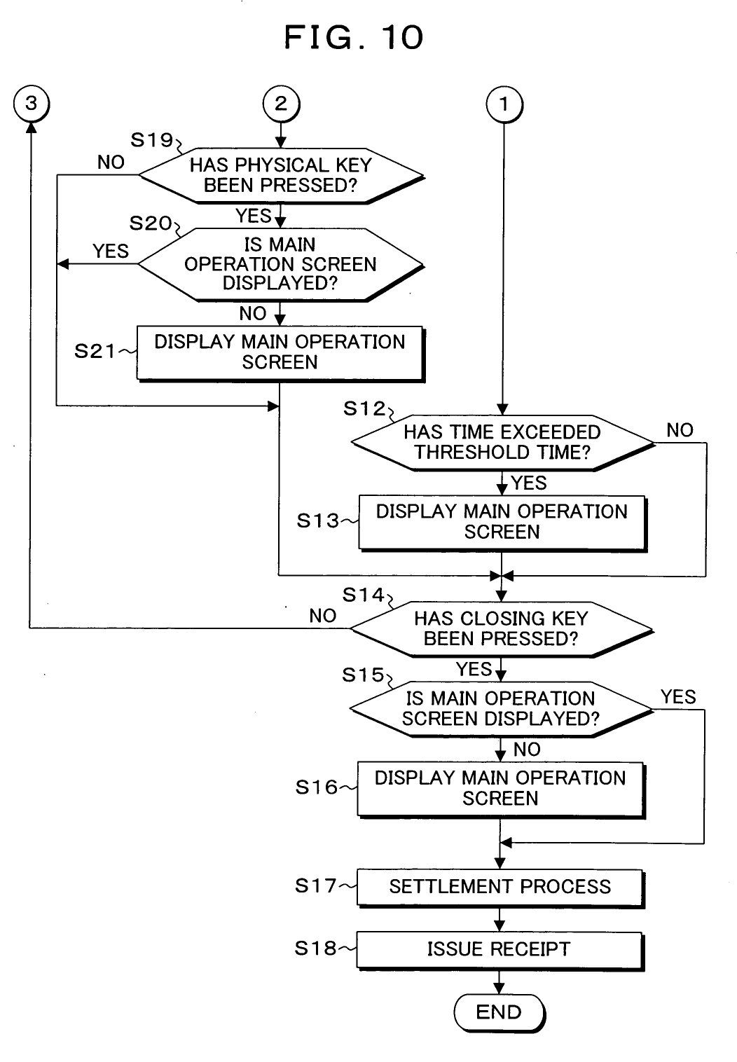

FIGS. 9 and 10 depict a flowchart of a control process for effecting a transition to a main operation screen by, in addition to monitoring time shown in the flowchart of FIGS. 7 and 8, pressing a physical key, according to the present invention. In FIGS. 9 and 10, steps S1 to S18 are identical to those of the control process in FIGS. 7 and 8 of effecting a transition to the main operation screen by monitoring time. In addition to this, steps S19 to S21 of a screen transition to the main operation screen by operating a physical key are newly provided. That is, after switching from the main operation screen to another operation screen and starting timer count in step S5, if a product key has not been pressed in step S8, the procedure goes to step S19, wherein it is checked whether a physical key has been pressed. The physical key to be determined in this step S19 as having been pressed or not is a number-of-products key, a discount key, a correction key, or the like provided on the physical keyboard 16 of FIG. 1. If any one of these physical keys has been pressed, the procedure goes to step S20, wherein it is checked whether the main operation screen is currently displayed. If another operation screen other than the main operation screen is displayed, a transition to the main operation screen is effected in step S21. Therefore, after the checker performs product registration by pressing a product key with switching from the main operation screen to another operation screen, when a physical key, such as a the number-of-products key, the discount key, the correction key, or the like is operated before the elapsed time monitored by the timer count exceeds the threshold time, a screen transition to the main operation screen is effected at that moment. As such, with the addition of the transition to the main operation screen by pressing a physical key, a more appropriate screen transition to the main operation screen can be performed, compared with the transition to the main operation screen by monitoring the switching time.

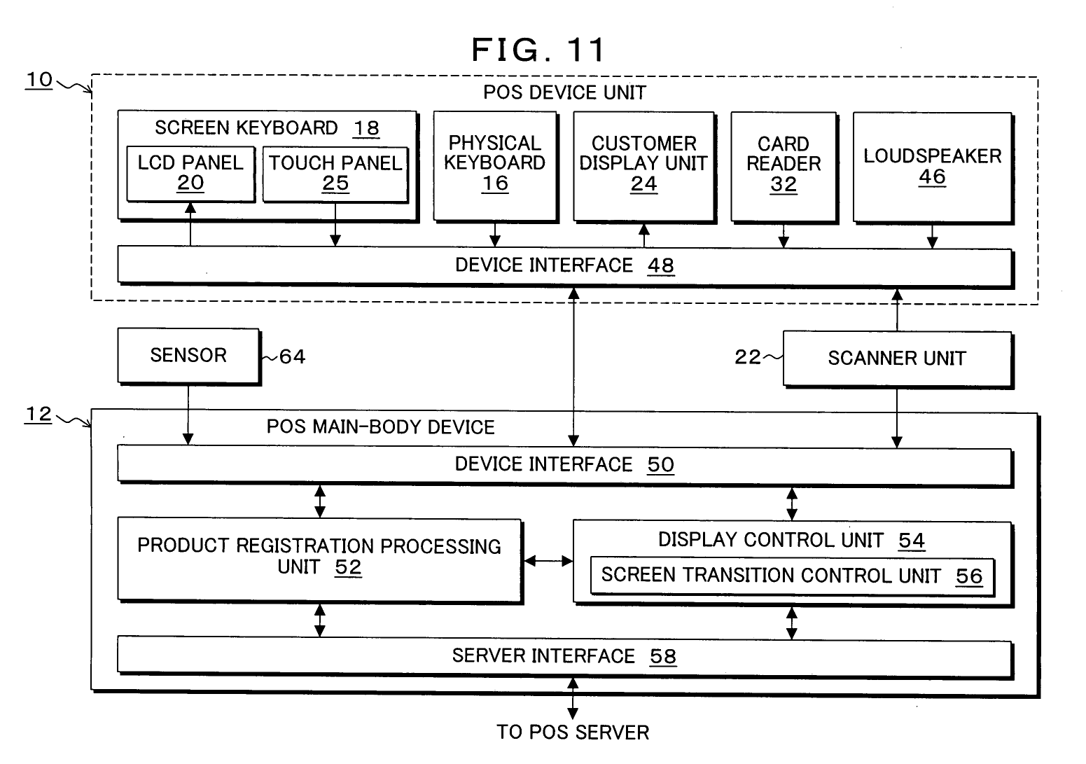

FIG. 11 is a block diagram of a functional configuration in which a condition for a screen transition to the main operation screen is detected by a dedicated sensor, according to another embodiment of the present invention. In FIG. 11, a POS device unit 10 side and a POS main-body device 12 are identical to those in the embodiment of FIG. 3, and a scanner unit 22 is also identical to that therein. In addition to this, in the present embodiment, a sensor 64 is newly provided to the POS main-body device 12. The sensor 64 detects a predetermined condition for a screen transition to the main operation screen after switching from the main operation screen to another operation screen at the POS device unit 10 side.

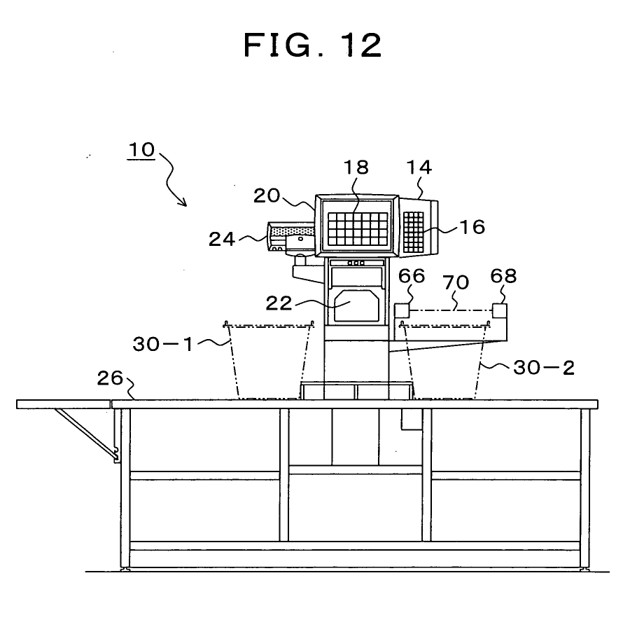

FIG. 12 depicts a specific example of the sensor 64 of FIG. 11. The present embodiment has a feature that a sensor is provided for detecting a movement of a product when the checker moves the product to a basket. In FIG. 12, for product registration by the checker using the POS device unit 10 disposed in a checkout lane, the checker picks up from a basket 30-1 the product put by the user therein, performs product registration through a scanner input by the scanner unit 22 or an operation on a product key on the screen keyboard 18, and then puts the product in a basket 30-2 placed on the opposite side. For such a movement of the product from the basket 30-1 to the basket 30-2 at the time of product registration by the checker, a sensor including a transmitter 66 and a receiver 68 is placed on the basket 30-2 side. The transmitter 66 and the receiver 68 are placed on an entrance portion from which a product on the top of the basket 30-2 is put. For example, the transmitter 66 is a light-emitting element and the receiver 68 is a light-receiving element. A light beam 70 from the transmitter 66 is incident to the receiver 68. When a product is put in the basket 30-2, the light beam 70 is interrupted, thereby detecting passage of the product with the receiver 68. With the use of the sensor formed of these transmitter 66 and receiver 68, a movement of a product from the basket 30-1 to the basket 30-2 is detected by the sensor, and the result is input to the POS main-body device 12 of FIG. 9 as a detection signal from the sensor 64. At this time, if the state is such that switching has been made to an operation screen other than the main operation screen, a transition to the main operation screen is effected.

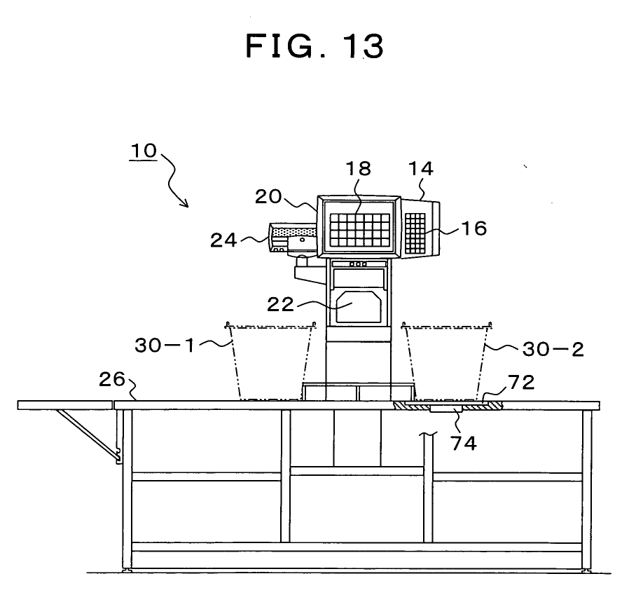

FIG. 13 is a drawing for describing a POS system provided with a load sensor, which serves as the sensor 64 for a transition to the main operation screen, for checking a change in weight when a product is put in a basket. In FIG. 13, in the POS device unit 10 on the desk 26 placed in the checkout lane, the checker picks up a product from the basket 30-1 and then performs product registration while moving the product to the other basket 30-2. In view of this, a movable plate 72 is placed at the disposition position of the basket 30-2. Under the movable plate 72, the load sensor 74 is provided. With this being the situation, when the checker uses the scanner unit 22 or the screen keyboard 18 to register a product and then puts the product-registered product in the basket 30-2, a change in weight of the basket 30-2 is detected by the load sensor 74, and then a detection signal of the load sensor 74 is given as a detection signal from the sensor 64 of FIG. 11 to the screen transition control unit 56 of the POS main-body control device 12. At this time, if the screen keyboard 18 has been switched to an operation screen other than the main operation screen, a transition to the main operation screen is effected.

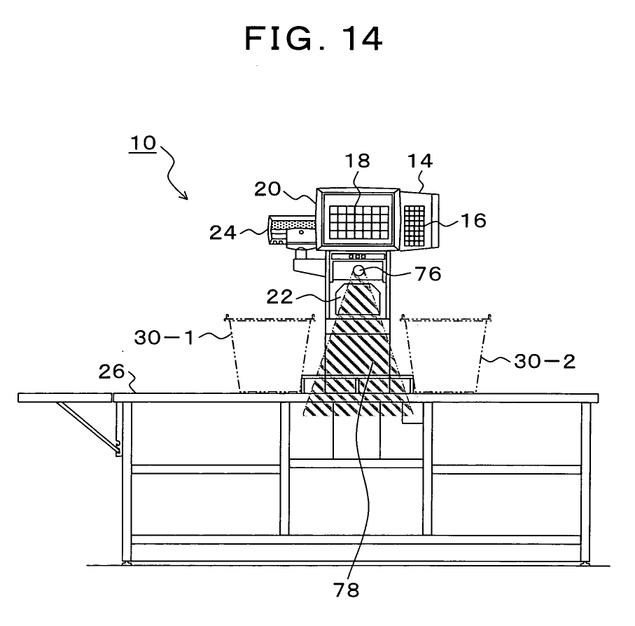

FIG. 14 is a drawing for describing a POS system in which a scanner unit side is provided with a sensor, which serves as the sensor for a screen transition to the main operation screen, for detecting a movement of the checker. In FIG. 12, a human-body sensor 76 is placed on a portion of the scanner unit 22 of the POS device unit 10 placed on the desk 26 in the checkout lane. The human-body sensor 76 has a monitoring area 78 toward the front, the area being represented by a diagonally-shaded portion and, if the checker is present in the monitoring area 78, outputs a human-body detection signal. To perform tasks of picking up a product from the basket 30-1, registering the product with the scanner unit 22 or the screen keyboard 18, and then moving the product to the basket 30-2, the checker moves his or her body from the front of the scanner unit 22 to the left side or the right side when picking up the product from the basket 30-1 and when putting the product in the basket 30-2. Thus, the body part of the checker is out of the monitoring area 78 of the human-body sensor 76, thereby interrupting the detection signal of the human-body sensor 76 to cause a non-detection state. Thus, the non-detection state in which the checker detection signal of the human-body sensor 76 is interrupted is recognized by the screen transition control unit 56 of FIG. 11. At this time, if the screen keyboard 18 has an operation screen other than the main operation screen, a transition to the main operation screen is effected. As a matter of course, the dedicated sensor of FIG. 11 for detecting a condition for control to the main operation screen is not restricted to the sensors of FIGS. 12 to 14, but an appropriate sensor can be used.

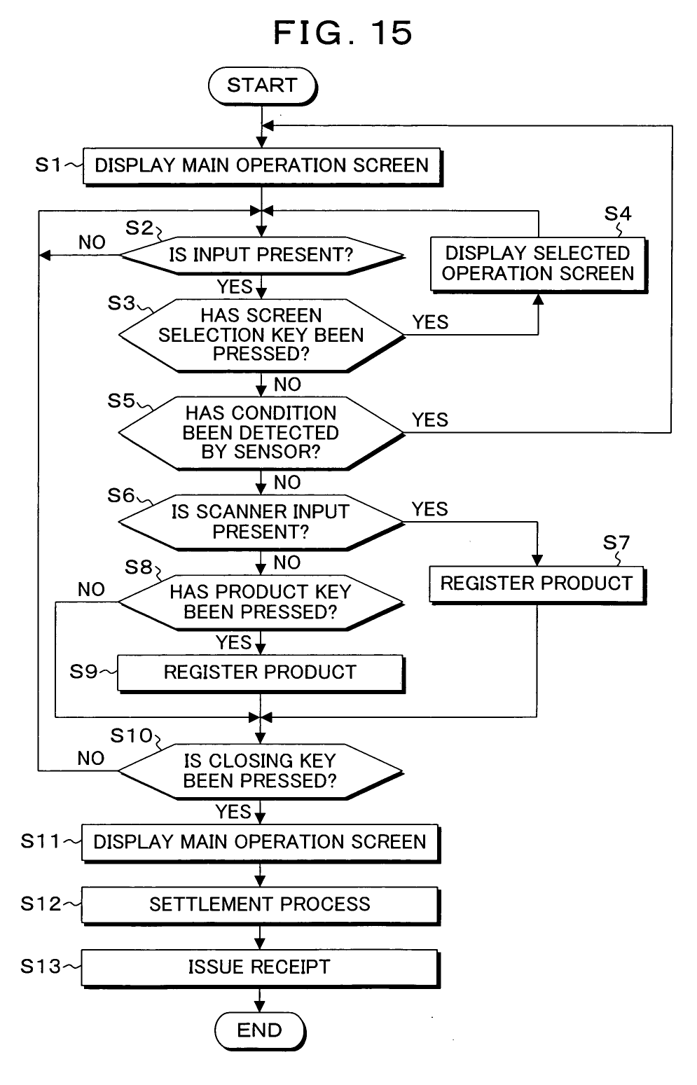

FIG. 15 is a flowchart of a control process for effecting a transition to the main operation screen by detecting a condition through the dedicated sensor 64 of FIG. 11, according to the present invention. In FIG. 15, in step S1, the main operation screen is displayed in an initial state. If it is determined is step S2 that an input is present and it is determined in step S3 that a screen selection key has been pressed, the selected operation screen is displayed in step S4, and then the procedure returns to step S2. If a product key is pressed in a state where switching has been made to an operation screen other than the main operation screen, it is determined in step S9 that the product key has been pressed, and then product registration is performed in step S9. Also, if a scanner input is provided by reading a bar code of a product through the scanner unit 22, it is determined in step S6 that a scanner input is present, and then product registration is performed in step S7. If a scanner input or pressing of a product key has been completed, in FIG. 12, for example, the product is put in the basket 30-2. Therefore, this is detected by the sensor formed of the transmitter 66 and the receiver 68, and then it is determined in step S5 that the condition has been detected by the sensor. Thus, the procedure returns from step S5 to step S1, wherein a transition to the main operation screen is effected. The same goes for the case of FIG. 13 where the load sensor 74 is used and also the case of FIG. 14 where a movement of the checker is detected by the human-body sensor 76. If product registration has been completed and it is determined in step S10 that the closing key has been pressed, a screen transition to the display of the main operation screen is effected in step S11 (only if screen switching has been made). Thereafter, a settlement process for payment of the total amount for the registered products is performed in step S12. Thereafter, a receipt is issued in step S13, and then a series of processes are caused to be terminated.

Note that the present invention is not restricted to the above-described embodiments, but includes appropriate modifications without impairing its objects and advantages. Also, the present invention is not restricted to numerical values presented in the above-described embodiment.

### INDUSTRIAL APPLICABILITY

As has been described in the foregoing, according to the present invention, when the main operation screen is switched to another operation screen and then product registration is performed by pressing a product key or through a scanner input, if a predetermined condition is satisfied, a control for effecting a transition to the main operation screen is performed without requiring a key operation. Thus, even if the operation screen is switched, the checker does not require an operation for putting the operation screen back to the original main operation screen, thereby reducing checker's tasks at the time of product registration with the screen keyboard that displays operation screens on the display panel with the touch panel and increasing task efficiency. Also, a condition for putting the operation screen back to the main operation screen is, in a state where switching to the operation screen has been made, a scanner input, pressing of a product key, monitoring of an elapsed time, pressing of a physical key, or condition detection by a dedicated sensor. With this, a screen transition to the main operation screen can be effected at appropriate timing after product registration by pressing a product key on the operation screen displayed by switching, thereby allowing an appropriate screen transition control for putting the operation screen back to the main operation screen so as not to hinder the timing of a product registration operation with the screen keyboard by the checker using the other operation screen displayed by switching from the main operation screen.

1. A product registration apparatus, comprising:
a screen keyboard that displays an operation screen having product keys arranged on a display panel having disposed thereon a touch panel, the screen keyboard causing a product registration process by an operation of the product keys; and
a screen transition control unit that causes a main operation screen and a screen selection key to be displayed on the display panel of the screen keyboard, recognizes satisfaction of a predetermined condition after switching from the main operation screen to another operation screen in accordance with an operation on the screen selection key, and effects a transition to the main operation screen.

2. The product registration apparatus according to claim 1, wherein the screen transition control unit effects a transition to the main operation screen from the operation screen after switching upon recognition of product registration by a scanner that reads a bar code of a product.

3. The product registration apparatus according to claim 1, wherein the screen transition control unit effects a transition to the main operation screen from the operation screen after switching upon recognition of an operation on a product key on the operation screen after switching.

4. The product registration apparatus according to claim 1, wherein the screen transition control unit monitors an elapsed time from a time when the main operation screen is switched to the other operation screen, and, upon recognition of an operation on a product key, resets the elapsed time to start monitoring the elapsed time from the beginning, and upon recognition of a lapse of a predetermined time without an operation on a product key, effects a transition to the main operation screen.

5. The product registration apparatus according to claim 4, wherein the screen transition control unit effects a transition to the main operation screen upon recognition of a key operation through a physical keyboard separately provided to the screen keyboard while monitoring the elapsed time.

6. The product registration apparatus according to claim 5, wherein the screen transition control unit effects a transition to the main operation screen upon recognition of an operation on a number-of-products key, a discount key, or a correction key through a physical keyboard.

7. The product registration apparatus according to claim 1, wherein the screen transition control unit effects a transition to the main operation screen upon recognition of non-detection of a checker by a sensor mounted on a scanner that reads a bar code of a product.

8. The product registration apparatus according to claim 1, wherein the screen transition control unit effects a transition to the main operation screen upon detection, by a sensor, of a movement of a registered product to a basket.

9. The product registration apparatus according to claim 1, wherein the screen transition control unit effects a transition to the main operation screen upon detection of a change in weight of the basket, the detection being made by a load sensor disposed on a lane on which a basket accommodating a product is placed,

10. A product registration control method with a screen keyboard that displays an operation screen having product keys arranged on a display panel having disposed thereon a touch panel, the screen keyboard causing a product registration process by an operation of the product keys, the method comprising:
an initial displaying step of causing a main operation screen and a screen selection key to be displayed on the display panel having disposed thereon the touch panel of the screen keyboard;
a screen switching step of switching from the main operation screen to another operation screen in accordance with an operation on the screen selection key; and
an initial screen transition step of recognizing satisfaction of a predetermined condition after the switching to the other operation screen, and effecting a transition to the main operation screen.

11. The product registration method according to claim 10, wherein, in the screen transition step, an elapsed time from a time when the main operation screen is switched to the other operation screen is monitored, and, upon recognition of an operation on a product key, the elapsed time is reset to start monitoring the elapsed time from the beginning, and upon recognition of a lapse of a predetermined time without an operation on a product key, a transition to the main operation screen is effected.

12. The product registration method according to claim 11, wherein the screen transition control step effects a transition to the main operation screen upon recognition of a key operation through a physical keyboard separately provided to the screen keyboard while monitoring the elapsed time.

13. A program that causes a computer including a product registration apparatus including a screen keyboard that displays an operation screen having product keys arranged on a display panel having disposed thereon a touch panel, the screen keyboard causing a product registration process by an operation of the product keys, to perform steps comprising:
an initial displaying step of causing a predetermined main operation screen and a screen selection key to be displayed on the display panel having disposed thereon the touch panel of the screen keyboard;
a screen switching step of switching from the main operation screen to another operation screen in accordance with an operation on the screen selection key; and
an initial screen transition step of recognizing satisfaction of a predetermined condition after the switching to the other operation screen, and effecting a transition to the main operation screen.

14. The program according to claim 13, wherein, in the screen transition step, an elapsed time from a time when the main operation screen is switched to the other operation screen is monitored, and, when an operation on a product key is recognized, the elapsed time is reset to start monitoring the elapsed time from the beginning, and when a lapse of a predetermined time is recognized without an operation on a product key, a transition to the main operation screen is effected.

15. The program according to claim 14, wherein the screen transition control step effects a transition to the main operation screen upon recognition of a key operation through a physical keyboard separately provided to the screen keyboard while monitoring the elapsed time.
